(19) United States
(12) Patent Application Publication
(10) Pub. No.: US 2019/0293468 A1
(43) Pub. Date: Sep. 26, 2019

(54) Injectable Medication Measurement Card

(71) Applicant: Christina Marie Michaels, Orange, CT (US)

(72) Inventor: Christina Marie Michaels, Orange, CT (US)

(21) Appl. No.: 15/928,025

(22) Filed: Mar. 21, 2018

(51) Int. Cl. G01F 23/02; A61J 1/22

(52) U.S. Cl. CPC G01F 23/02; A61J 1/18; A61J 1/22

(57) ABSTRACT

A graduated measurement card used to measure the liquid contents of a bottle without having to breach the bottle, with a syringe or extraction tool, to obtain accurate volume measurements. The measurement card is made with specific markings, in milliliter increments, pertaining to the liquid contents being measured. Depending on the volume size of the bottle, the measurement card will match specifically to where the bottom of the bottle begins and the liquid at the top of the bottle ends. The markings will be spaced out in increments of 5 milliliters or less to be able to adequately measure the liquid in the bottle. The card is not limited to measuring injectable medication, but rather any liquid in a bottle or container that requires a graduated measurement without having to transfer the contents of the bottle.

### CROSS REFERENCE TO RELATED APPLICATIONS

There are no references to this specific invention listed in the patent database.

### FIELD OF INVENTION

The present invention is related, generally, to the field of medication measurements. More specifically, embodiments of the present invention are related to the conventional methods for counting inventory for opened medication bottles that are used in the administration of medications to patients, particularly via a syringe.

### BACKGROUND

The process of conducting physical inventory in a hospital setting for open, liquid bottles of medication, generally requires a syringe inserted into the bottle to obtain accurate measurement for what is left in the bottle. Each time a syringe is inserted into the bottle to obtain a volume measurement, the sterility of the medication is breached, medication is lost in the hub of the syringe and the individual physically drawing the medication out of the bottle via the syringe runs the risk of being pricked by the needle each time. Should the individual become distracted during this process, there is also a possibility of inserting the contents of the syringe back into a bottle for a different medication. This poses a risk to the patient, assuming the medication in the bottle is what the bottle states on the label, however it could actually be a different medication entirely.

### SUMMARY OF INVENTION

An invention that measures the contents of a liquid medication, from the outside of the bottle, saves the individual counting physical inventory, time. It also allows for accurate volume measurements without breaching the sterility of the medication. Safety of the individual drawing up the medication, with a syringe, to accurately account for volume measurements is increased because there would not be a need to utilize a syringe running the risk of exposure with regard to safety concerns. Patient safety is also increased since none of the medication from the bottle is extracted, during the measurement process, running the risk of cross-contamination or refilling a different bottle with the medication extracted from another. Lastly, syringe and needle waste is significantly decreased for the purpose of using a syringe/needle combination in order to measure liquid volumes accurately for each liquid medication a hospital carries, multiplied by the number of inventory counts conducting utilizing a separate syringe/needle combination for each separate bottle.

It is the purpose of this invention to increase the safety of the personnel handing the medication and patients the medications are being administered to while significantly driving down waste costs and increasing physical inventory count efficiency.

### BRIEF DESCRIPTION OF DRAWINGS

FIG. 1 illustrates the front view of the laminated measurement card with graduated markings in increments of 5 milliliters spaced evenly;

FIG. 2 illustrates the front view of the laminated measurement card measuring the volume contents, in milliliters, for what is left in the 70 milliliter bottle.

### DETAILED DESCRIPTION OF DRAWINGS

The purpose of this invention is to provide accurate results, when measuring liquid volumes in milliliter increments, without having to breach the bottle with a syringe or extraction tool, to obtain results. By not breaching the bottle with a syringe or extraction tool, the medication remains sterile and does not become contaminated. In addition, the individual measuring the volume of the bottle is not subjected to needle sticks or direct exposure from the contents in the bottle being measured.

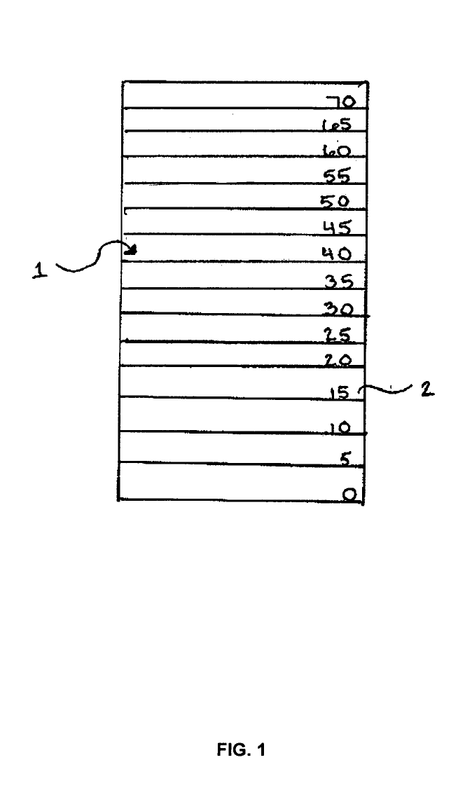

FIG. 1 depicts the laminated Injectable Medication Measurement Card 1. In FIG. 1, the 5 millimeter increments spaced evenly are shown marked on the Injectable Medication Measurement Card 2.

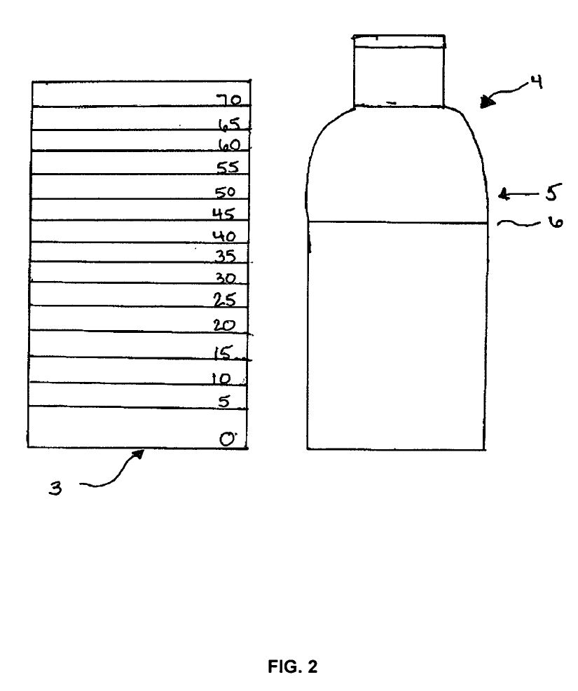

FIG. 2 depicts the laminated Injectable Medication Measurement Card with 5 millimeter increments spaced evenly 3. FIG. 2 represents the top of the bottle being measured 4. FIG. 2 represents the bottle being measured that is large enough to hold 70 milliliters of liquid 5. FIG. 2 shows the volume of liquid left in the 70 milliliter bottle and represents a 45 milliliter volume based on the measurement card marking 6.

What is claimed is:

1. An measurement card used to measure the liquid contents of a bottle, comprising of a laminated ruler-like measurement device having markings noted on the card in increments of 5 milliliters or less; indicia marked on the card showing the volume of the bottle being measured and lining up to the volume line in the bottle for the liquid that is left in the bottle matching with the milliliter [symbol]
